(19) United States
(12) Patent Application Publication
(10) Pub. No.: US 2015/0192934 A1
(43) Pub. Date: Jul. 9, 2015

(54) APPARATUS FOR CONTROLLING PRESSURE AND FLOW OF GASES, PARTICULARLY IN MINING APPLICATIONS

(71) Applicant: PARKER-HANNIFIN CORPORATION, Cleveland, OH (US)

(72) Inventors: Joseph John Lis, San Francisco, CA (US); Daniel Paul Morgan, Vacaville, CA (US)

(21) Appl. No.: 14/414,563

(22) PCT Filed: Jul. 15, 2013
(86) PCT No.: PCT/US13/50466

§ 371 Date: Jan. 13, 2015

Related U.S. Application Data
(60) Provisional application No. 61/671,276, filed on Jul. 13, 2012.

(51) Int. Cl. G05D 16/10; F16K 1/04; F16K 1/42

(52) U.S. Cl. CPC G05D 16/103; F16K 1/42; F16K 1/04

(57) ABSTRACT

A regulator, valve and regulator system for regulation of pressure and flow of gas from a source to the environment, such as from a highly pressurized oxygen source in an emergency life support system to the surrounding environment. The regulator includes redundant flow paths and redundant stages for reliable control of gas pressure from the source. The valve includes a unique valve seat assembly and a bonnet assembly sealed both from the environment and from the gas flowing through the valve for control of flow of gas from the source.

### RELATED APPLICATIONS

This application claims the benefit of U.S. Provisional Application No. 61/671,276 filed Jul. 13, 2012, which is hereby incorporated herein by reference.

### FIELD OF INVENTION

The invention relates to an apparatus for regulation of pressure and flow of gas from a source to the environment, and particularly to a regulator having redundant flow paths and redundant stages for reliable control of gas pressure from a source, and also to a valve having a unique valve seat assembly and a bonnet assembly sealed both from the environment and from the gas flowing through the valve for control of flow of gas from a source.

### BACKGROUND

Flow systems for delivering pressure and flow from a source often encounter problems such as blockages, leakage, pressure fluctuations, and component failure. Current systems are often critical systems and are not made to deal with most or all of these problems.

For example, lifesaving systems help mitigate the risks associated with mining operations. These systems take the form of enclosures with breathing oxygen available in the event the local atmosphere becomes contaminated. The oxygen delivery systems use highly pressurized oxygen, typically greater than 4500 psi, to store enough oxygen to sustain a large crew of miners for up to 4 days.

In the event of an emergency, the system provides a continuous flow of oxygen. Existing systems have experienced problems that can affect the performance primary functions. For example, ice blockage or debris in the flow path can lead to flow issues. Moreover, because the systems are only active during emergencies, operator maintenance or even intervention may be impossible during use.

It would be preferable if such systems were less likely to experience problems, particularly during emergencies.

### SUMMARY OF THE INVENTION

There is provided a gas supply system for delivering a continuous stream of gas from a source, the gas supply system including a regulator/regulator system and valve. According to one aspect of the invention, the regulator/regulator system may have primary and secondary redundant flow paths machined within the same regulator body such that there are no additional fittings or leak paths. According to another aspect of the invention, a second stage regulator, also plumbed with primary and secondary flow paths, may be included. The second regulator may be capable of maintaining a safe delivery pressure if a first regulator fails in a full open condition. According to a further aspect of the invention, the valve includes a valve keeper for retaining a valve seat and which minimizes direct impact of the high velocity flow on the valve seat material, as is preferred for sealing the valve. According to another aspect of the invention, valve materials coming in contact with the oxygen or air flow stream are materials known to minimize the risk of fire associated with oxygen. Materials exposed to the external environment are resistant to corrosive atmospheres. According to still another aspect of the invention, a sealed bonnet system of the valve protects internal components from the external environment and from high velocity flow through the valve. According to yet another aspect of the invention, the risk of fire is further reduced by isolating the valve stem threads and eliminating springs from the oxygen or air flow stream.

Accordingly, there is provided a gas supply assembly for controlling a flow and regulating a pressure of gas from a source. The assembly comprises a valve for controlling the flow of gas from at least one gas vessel. The valve comprises a body having an inlet passage and an outlet passage, wherein the inlet passage is in fluidic communication with a valve chamber; a valve piston associated with the valve chamber and receiving a valve keeper and a valve seat, wherein the valve keeper is positioned in the path of the flow into the valve chamber and is impacted upon by the flow; and a bonnet assembly for engaging with the valve piston and isolating at least part of at least one component from flow through the body and from the environment, wherein the bonnet assembly is adapted to move the valve piston within the valve chamber causing the valve seat to engage or disengage the sidewall. The assembly also includes a regulator for regulating the pressure of a gas from the at least one gas vessel, connected downstream of the valve. The regulator comprises a housing; a primary flow path and a secondary flow path within the housing, the primary flow path providing for flow from the inlet to the outlet through a primary chamber, and the secondary flow path providing for flow from the inlet to the outlet through a secondary chamber; a connecting passage providing fluidic communication between the primary chamber, the secondary chamber, and the outlet; a primary valve system housed within the primary chamber for opening and closing the primary flow path; a secondary valve system housed within the secondary chamber for opening and closing the secondary flow path; a primary biasing element housed within the primary chamber and engaging the primary valve system; and a secondary biasing element housed within the secondary chamber and engaging the secondary valve system. Each of the biasing elements is adapted to bias the respective valve system in an open position allowing flow from the inlet to the outlet, and is also adapted to close the respective valve system when exposed to a pressure at the outlet sufficient to create a force equal to or greater than a biasing force of the respective biasing element.

The primary biasing element and the secondary biasing element may be adjusted to different biasing forces and/or the primary biasing element may be adjusted to a primary biasing force greater than a secondary biasing force of the secondary biasing element.

The primary biasing element and the secondary biasing element may be adjusted such that when gas flows in the inlet and out the outlet, the primary biasing force of the primary biasing element overcomes the pressure resulting from flow from the inlet and pressure at the outlet such that the primary valve system is open, and the pressure resulting from flow from the inlet and pressure at the outlet overcome the secondary biasing force of the secondary biasing element closing the secondary valve system.

A restriction of the primary flow path may cause a decrease of the pressure resulting from flow from the outlet, thereby causing the secondary biasing force of the secondary biasing element to overcome the pressure resulting from flow from the outlet opening the secondary valve system. In a preferred arrangement, no operator intervention is required to open the secondary valve system.

The primary valve system may comprise a primary valve member centrally deposed to a primary valve seat and engaged with the primary biasing element such that an increase of the pressure resulting from flow to the primary chamber causes the primary valve member to move axially towards the primary valve seat, and a decrease of the pressure resulting from flow from the primary chamber causes the primary valve member to move axially away from the primary valve seat.

The secondary valve system may comprise a secondary valve member centrally deposed to a secondary valve seat and engaged with the secondary biasing element such that an increase of the pressure resulting from flow to the secondary chamber causes the secondary valve member to move axially towards the secondary valve seat, and a decrease of the pressure resulting from flow from the secondary chamber causes the secondary valve member to move axially away from the secondary valve seat.

The connecting passage may form part of at least one of the primary flow path or the secondary flow path.

At least one of the primary valve seat or the secondary valve seat may comprise at least one of a nickel alloy or a polyimide-based plastic.

The primary biasing element may be sealed off from flow through the primary flow path and from the environment by at least one primary sealing element.

The at least one primary sealing element and/or secondary sealing element may comprise a fluoroelastomer, polytetrafluoroethylene, silicone, or fluoropolymer.

The secondary biasing element may be sealed off from flow through the secondary flow path and from the environment by at least one secondary sealing element.

A passageway may provide for fluidic communication between the inlet passage and the valve chamber and may have an opening, wherein the valve keeper has a diameter at least as great as a diameter of the opening.

The valve keeper may be centrally deposed to the valve seat and/or may retain the valve seat in the valve piston.

The valve piston may have a bore for receiving the valve keeper, the valve keeper may have a contact surface positioned in the path of the flow into the valve chamber, and/or the valve keeper may have an orifice extending through the valve keeper from the contact surface to the bore.

At least one of the valve keeper (416) or the valve seat (418) may comprise at least one of a nickel alloy or a polyimide-based polymer.

The at least one component may be isolated from flow through the body and from the environment by at least one sealing element.

The at least one sealing element may comprise at least one of a fluoroelastomer, a polytetrafluoroethylene, a silicone, or a fluoropolymer.

The at least one component comprises at least one of a stem extending through the bonnet assembly and engaged with the body and the valve piston; or the valve piston engaged with the stem.

The at least one component may include threads.

The bonnet assembly may comprise an upper bonnet cap engaged with the body; a stem extending through the upper bonnet cap and engaged with the valve piston; a lower bonnet portion configured to receive the valve piston and engaged with the upper bonnet cap and the body; and a connecting element outside the bonnet assembly connecting an operator member outside the bonnet assembly to the stem; wherein rotation of the operator member causes rotation of the stem, thereby causing the valve piston to move within the bonnet assembly, thereby causing the valve seat to engage or disengage the sidewall of the valve chamber.

The valve piston may be comprised of a lower valve piston body for receiving the valve keeper and the valve seat and having the bore; and an upper driver body connected to a stem and engaged with the lower valve piston body, wherein the stem extends through the bonnet assembly and engages with the body.

According to a further aspect of the invention, a regulator system for regulating the pressure of a gas from the at least one gas vessel, connected downstream of the valve, wherein the regulator system comprises a first regulator as above described and a second regulator connected in series with the first regulator, with an outlet of the first regulator in fluidic communication with an inlet of the second regulator.

The invention also provides a method of using a regulator as herein described for controlling the pressure resulting from a gas flowing from a source, the method comprising the steps of adjusting at least one of the primary biasing element or the secondary biasing element such that the primary biasing element has a primary biasing force greater than a secondary biasing force of the secondary biasing element.

According to still another aspect of the invention, a regulator for regulating the pressure of a gas from a source, comprises a housing; a primary flow path and a secondary flow path within the housing, the primary flow path providing for flow from an inlet to an outlet through a primary chamber, and the secondary flow path providing for flow from the inlet to the outlet through a secondary chamber; and a connecting passage providing fluidic communication between the primary chamber, the secondary chamber, and the outlet; a primary valve system housed within the primary chamber for opening and closing the primary flow path, and a secondary valve system housed within the secondary chamber for opening and closing the secondary flow path; a primary biasing element housed within the primary chamber and engaging the primary valve system, and a secondary biasing element housed within the secondary chamber and engaging the secondary valve system; wherein each of the biasing elements is adapted to bias the respective valve system in an open position allowing flow from the inlet to the outlet, and is also adapted to close the respective valve system when exposed to a pressure at the outlet sufficient to create a force equal to or greater than a biasing force of the respective biasing element.

According to yet a further aspect of the invention, a valve for controlling a flow of a gas from a source comprises a body having an inlet passage and an outlet passage, wherein the inlet passage is in fluidic communication with a valve chamber; a valve piston associated with the valve chamber and receiving a valve keeper and a valve seat, wherein the valve seat cooperates with a sidewall of the valve chamber to seal off the flow to the valve chamber, and wherein the valve keeper is positioned in the path of the flow into the valve chamber and is impacted upon by the flow; and a bonnet assembly for engaging with the valve piston and isolating at least part of at least one component from flow through the body and from the environment, wherein the bonnet assembly is adapted to move the valve piston within the valve chamber causing the valve seat to engage or disengage the sidewall.

The foregoing and other aspects and features of the invention are hereinafter described in reference to the drawings.

### BRIEF DESCRIPTION OF THE DRAWINGS

FIG. 1 is a schematic diagram of a gas supply system;

FIG. 2 is a cross-sectional view of a regulator of the gas supply system of FIG. 1;

FIG. 3 is a cross-sectional view of a regulator system of the gas supply system of FIG. 1; and

FIGS. 4 through 8 are perspective views of a valve of the gas supply system of FIG. 1.

### DETAILED DESCRIPTION

Flow systems for delivering pressure and flow from a source are often critical systems relied upon for safety. For example, oxygen-delivering lifesaving systems are in place to provide emergency oxygen to a crew of miners in the case of an emergency. These lifesaving systems often take the form of enclosures providing breathing oxygen that is available in the event the local atmosphere becomes contaminated.

The present invention relates to regulators or regulator systems for assisting with delivery of gases, and preferably to regulators and regulator systems having particular application for the delivery of oxygen to miners and the like in the case of an emergency. The regulator or regulator system provides for backup flow passages that enable a continuous supply of gas, in particular oxygen or air, if the pressure in the primary flow path drops. The secondary flow path may be engaged without operator intervention. The primary and secondary flow paths may be machined within the same regulator body, for example, to minimize fittings and leak paths.

Additionally, a second stage regulator, also plumbed with primary and secondary flow paths, may be included. The second stage regulator may be capable of maintaining a safe delivery pressure even if a connected regulator fails in a full open condition.

The present invention also relates to valves and a system for assisting with delivery of liquids, gases, or a combination thereof using valves. The valve may provide for reduced risk of fire associated with high pressure oxygen and air while providing resistance to corrosive environments, such as in mines, chemical plants, or marine environments.

The portions of the valve coming in contact with the air flow stream, such as an oxygen stream, may be made of materials known to minimize the risk of fire associated with the respective air flow stream.

The portion of the valve exposed to the external environment may be resistant to corrosive atmospheres.

A sealed bonnet system protects internal components from the external environment and from high velocity flow through the valve.

In addition, the valve stem threads may be isolated.

Also, the valve may include a springless design.

Additionally, a valve keeper may be included to minimize direct impact of the high velocity flow on the valve seat material.

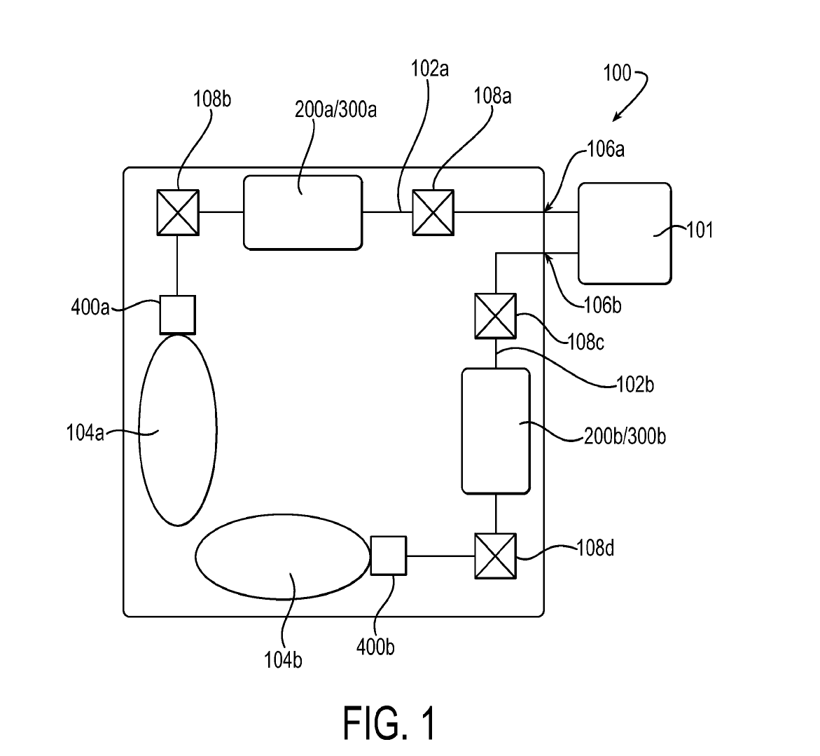

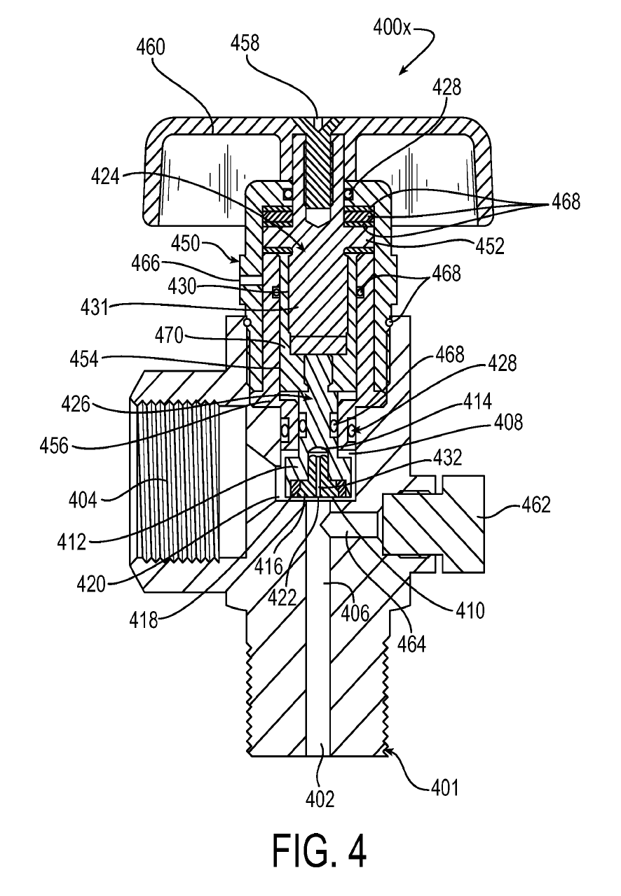

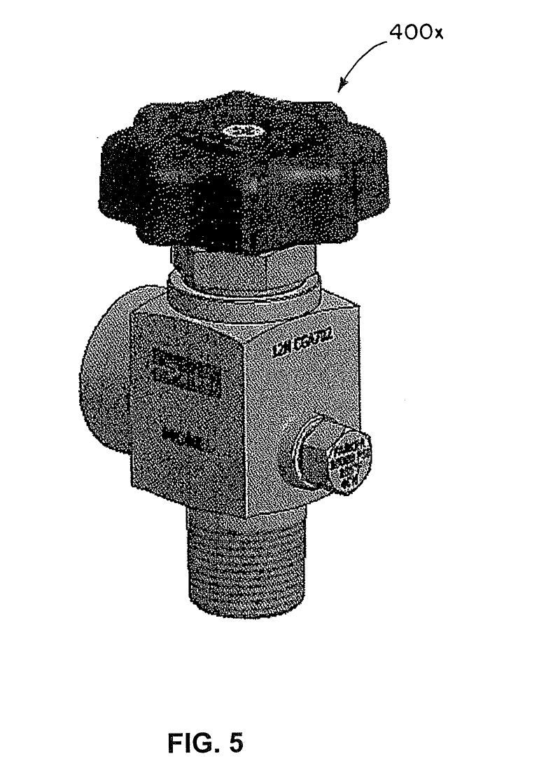

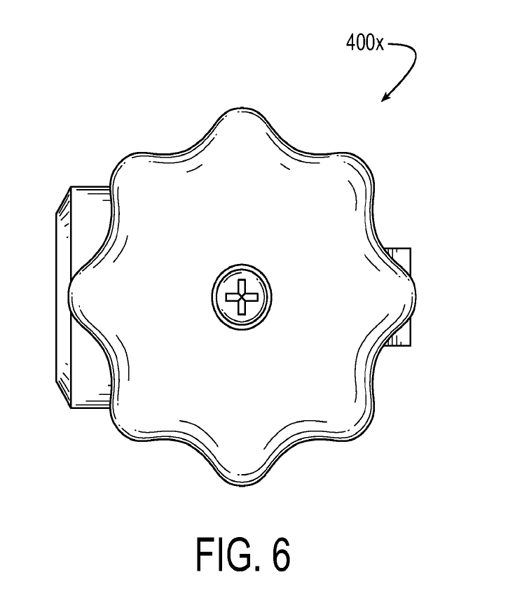

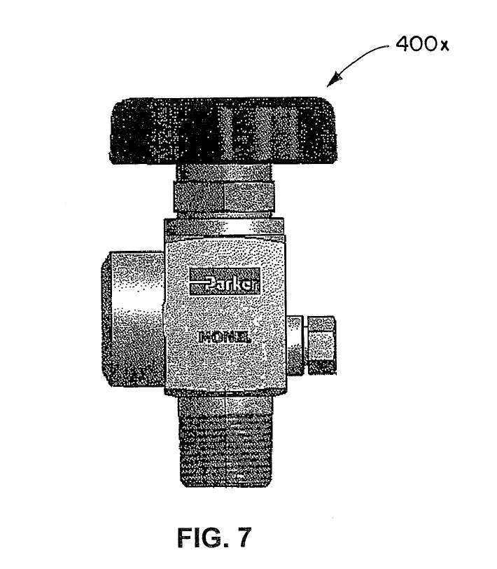

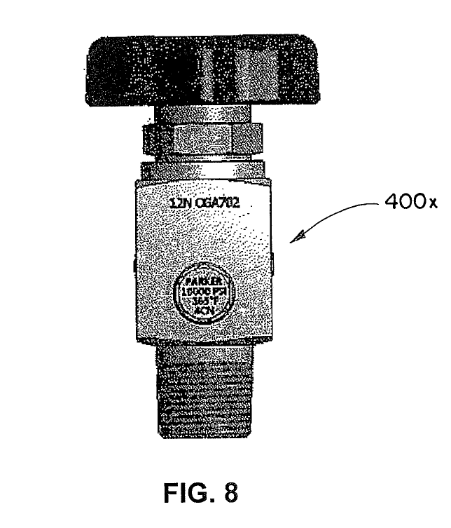

Turning first to FIG. 1, a schematic diagram of a system 100 for the delivery of gases to a device 101 for receiving, mixing, and/or delivering said gases to the environment is shown. FIG. 1 represents an ideal system having a gas assembly 102a for delivering a first gas, such as air, and a gas assembly 102b for delivering another gas, such as oxygen. As shown, each assembly 102x (x is used to denote either a or b in the respective systems) may include a gas vessel 104x and a valve 400x connected in series downstream of the gas vessel 104x for controlling a flow of gas, as separately shown in FIGS. 4 through 8. The device may, for example, mix gases from different sources for supply to an enclosed environment, such as mine tunnel.

It will be appreciated that “x” is used herein as a place holder to generally refer to any other specific component such as “a” or “b.” For example, assembly 102x may generally refer to either of assembly 102a or assembly 102b.

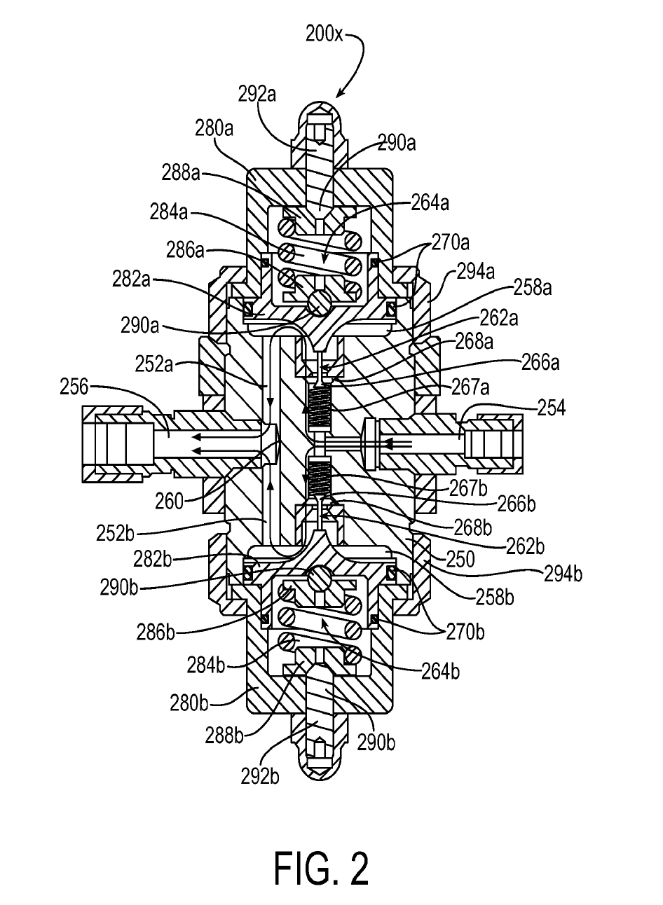

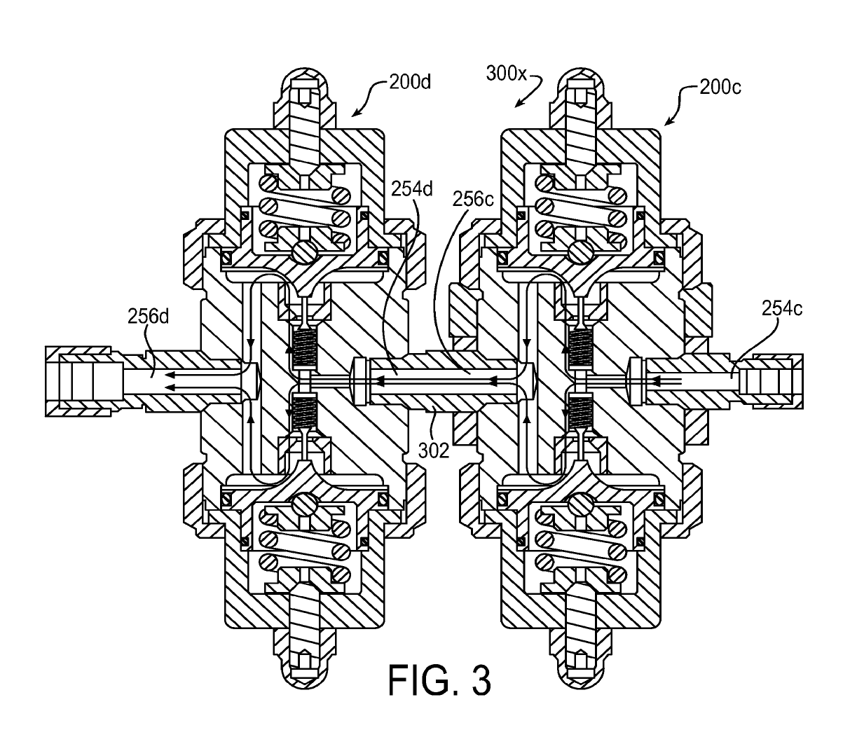

The valve 400x as shown is connected in the gas assembly 102x upstream of an outlet of the system 106x. Each assembly 102x may also include a regulator 200x or a regulator assembly 300x connected in series downstream of the gas vessel 104x for regulating the pressure of a gas, as separately shown in FIGS. 2 and 3, respectively, and also previously described. The regulator 200x or regulator system 300x is connected in the gas assembly 102x upstream of an outlet of the system 106x.

Additionally, each assembly 102x may include a filter 108x interposed in series between the valve 400x and the regulator 200x or the regulator system 300x.

Each assembly 102x may also include a filter 108x interposed in series between the regulator 200x or the regulator system 300x and the outlet of the system 106x.

The outlets 106a and 106b may be combined or may be separate.

Turning next to FIG. 2, a cross-sectional view of a regulator, such as regulator 200c or 200d, for controlling the pressure resulting from the flow of gas from a source is illustrated. The regulator 200x has a single housing 250 with a single inlet 254 and a single outlet 256. The housing 250 contains a primary flow path 252a and a secondary flow path 252b. The use of a single housing 250 for the primary flow path 252a and secondary flow path 252b may advantageously eliminate the T-fittings and connectors that would otherwise be present in such a system, thereby reducing the number of potential interfaces where leakage may occur.

The primary flow path 252a and the secondary flow path 252b provide for flow from the inlet 254 to the outlet 256. It will be understood by those of ordinary skill in the art that as gas initially flows into the inlet 254 of the regulator 200, it will flow through both of the primary flow path 252a and the secondary flow path 252b.

Turning first to the primary flow path 252a, gas will flow past the primary valve system 262a for opening and closing the primary flow path 252a. The primary valve system 262a includes a primary valve seat 268a and a primary valve member 266a. The primary valve member 266a provides for a seal against the primary valve seat 268a and for closure of the primary flow path 252a.

Gas from the inlet 254 will thus initially flow past the primary valve seat 268a and into the primary chamber 258a. The gas will communicate with a primary biasing element 264a housed within the primary chamber 258a.

The primary biasing element 264a may be adjustable to a primary biasing force.

The primary biasing element 264a may also be adapted to engage the primary valve system 262a and to provide for the opening and closing of the primary valve system 262a via compression and relaxation of the primary biasing element 264a. Particularly, movement of the primary valve member 266a towards the primary valve seat 268a may be provided by a compression of the primary biasing element 264a when exposed to a pressure of the gas flowing from the inlet 254. Alternatively, movement of the primary valve member 266a away from the primary valve seat 268b may be provided by a relaxation of the primary biasing element 264a when exposed to a reduced pressure or no pressure due to reduced flow or no flow from the inlet 254.

A primary valve spring 267a may be present in the primary valve system 262a and may be engaged with the primary valve member 266a. The primary valve spring 267a may provide a force to the primary valve member 266a to maintain seal against the primary valve seat 268a. Specifically, this action may occur when the force resulting from pressure of the gas flowing from the inlet 254 overcomes the biasing force of the primary biasing element 264a. For example, the primary biasing element 264a may be adjusted to a predetermined primary biasing force that may be overcome by the force resulting from the gas flowing from the inlet 254.

The primary valve member 266a may be centrally deposed to the primary valve seat 268a, which may be annular in shape as shown or of any other suitable shape, in order to provide efficient sealing of the primary valve member 266a against the primary valve seat 268a.

The primary valve seat 268a may be made of a nickel alloy or a polyimide-based plastic, such as Monel or Vespel, or may be made of any other suitable material.

The primary biasing element 264a may have multiple elements allowing it to compress and relax when acted upon by a pressure of gas flowing through the regulator. As shown, the multiple components of the primary biasing element 264a include a primary cap portion 280a engaging the housing 250. A primary regulator piston 282a engages both the housing 250 and the primary cap portion 280a. A primary spring 284a is interposed between a primary first spring retainer 286a and a primary second spring retainer 288a, the spring retainers themselves floating interposed between the primary regulator piston 282a and the primary cap portion 280a.

The spring retainers may be floating by way of cylindrical or ball protrusions 290a, wherein at least one of the cylindrical or ball protrusions 290a is deposed on an end of a primary adjustment stem 292a. The protrusions 290a may also be of any other suitable shape.

The primary adjustment stem 292a is preferably threaded through the primary cap portion 280a, wherein rotation of the primary adjustment stem 292a causes adjustment of the distance between the primary first spring retainer 286a and the primary second spring retainer 288a, thereby enabling adjustment of the primary biasing force of the primary biasing element 264a.

Further, the primary cap portion 280a may be threaded to the housing 250 or may be engaged with the housing 250 by a primary collar 294a, itself attached to the housing 250 via cooperating threading of the housing 250 and cap portion 280a, or via other suitable structure.

Additionally, according to another aspect of the invention, the internal elements of the primary biasing element 264a are sealed off from flow through the primary flow path 252a and from the environment by at least one primary sealing element 270a.

The internal elements of the primary biasing element 264a may include, for example, the primary spring 284a, the primary first spring retainer 286a, the primary second spring retainer 288a, and the primary cylindrical or ball protrusions 290a. As shown, primary sealing elements 270a are disposed between the primary regulator piston 282a and the housing 250 and also between the primary regulator piston 282a and the primary cap portion 280a. One or more of the sealing elements 270a may be made of a fluoroelastomer, a polytetrafluoroethylene, a silicone, or a fluoropolymer, such as Teflon or Viton, or may be made of any other suitable material.

Accordingly, in use of the regulator 200x, gas will flow from the inlet 254, past the spring 267a and valve seat 268a and into the primary valve chamber 258a, where it may act upon the primary biasing element 264a. Such action may overcome the predetermined biasing force of the biasing element 264a, causing compression of the biasing element 264, and allowing the primary valve member 266a to move towards the primary valve seat 268a via the spring 267a. The primary valve system 262a will thereby be caused to fully close until the force resulting from pressure of the gas flowing from the inlet 254 is reduced to a level lower than the primary biasing force.

In addition, opening of the primary valve system 262a via movement of the primary valve member 266a away from the primary valve seat 268a may be provided by a relaxation of the primary biasing element 264a. Specifically, this action may occur when the primary biasing element 264a is exposed to a decreasing force resulting from pressure of gas flowing from the primary chamber 258a to the outlet 256. The primary biasing force of the primary biasing element 264a may thereby overcome the decreasing pressure within the primary chamber 258a, and may also thereby overcome the primary valve spring 267a allowing the primary valve member 266a to move away from the primary valve seat 268a. The primary valve system 262a may thereby be caused to reopen and again allow flow of gas from the inlet 254 into the primary chamber 258a until a force resulting from pressure of the gas flowing from the inlet 254 again overcomes the primary biasing force of the primary biasing element 264a. This sequence will continue allowing for regulation of the pressure of a gas flowing through the primary flow path 252a from the inlet 254 to the outlet 256.

Turning now to the secondary flow path 252b, the same sequence initially occurs whereby the pressure resulting from the flow of gas from the inlet 254 past a secondary valve system 262b and into a secondary chamber 258b causes a secondary biasing element 264b to close the secondary valve system 262b. As illustrated, the secondary biasing element 264b, which may be adjustable to a secondary biasing force, engages the secondary valve member 266b of the secondary valve system 262b causing it to move towards the secondary valve seat 268b, also of the secondary valve system 262b, as the secondary biasing element 264b compresses.

The secondary valve member 266b and secondary valve seat 268b may be made of the same suitable materials as the primary valve member 266a and primary valve seat 268a, respectively, or may be made of other suitable material.

As in the primary flow path 252a, a secondary valve spring 267b in the secondary flow path 252b, in association with the secondary valve system 262b, may provide a force to the secondary valve member 266b, enabling it to maintain seal against the secondary valve seat 268b.

Similar to the primary biasing element 264a, the secondary biasing element 264b, may include a secondary cap portion 280b, a secondary collar 294b, a secondary regulator piston 282b, a secondary spring 284b, a secondary first spring retainer 286b, a secondary second spring retainer 288b, secondary cylindrical or ball protrusions 290b, and a secondary adjustment stem 292b.

Further, the internal elements of the secondary biasing element 264b, respectively, are sealed off from flow through the secondary flow path 252b and from the environment by at least one secondary sealing element 270b made of the same or different suitable material as the primary sealing element 270a.

Like the primary biasing element 264a, the secondary biasing element 264b may have an adjustable biasing force. If the secondary biasing element 264b has a secondary biasing force equal to the primary biasing force of the primary biasing element 264a, gas will flow through both the primary flow path 252a and the secondary flow path 252b. Those with ordinary skill in the art will recognize that if the primary biasing element 264a has a primary biasing force greater than the secondary biasing force of the secondary biasing element 264b, only flow through the primary flow path 252a will occur. Particularly, when used with a high pressure gas, when the biasing elements are adjusted for use with the high pressure gas, and when the primary biasing force is adjusted to be greater than the secondary biasing force, high pressure flow from the inlet 254 will cause the primary valve system 262a to cycle between open and closed states while maintaining closure of the secondary valve system 262b.

A connecting passage 260 provides fluidic communication, including communication of gases, liquid, or a combination thereof, between the primary chamber 258a and the secondary chamber 258b.

The connecting passage 260 may be part of one or both of the primary flow path 252a or the secondary flow path 252b.

In addition, the connecting passage 260 may provide an alternative path for fluidic communication between the primary chamber 258a and the secondary chamber 258b that is separate from one or both of the primary flow path 252a or the secondary flow path 252b.

As such, a pressure from the outlet 256 may cause a pressure within the primary chamber 258a to equalize with a pressure within the secondary chamber 258b. Such equalization will be controlled by the greater of the primary biasing force of the primary biasing element 264a or the secondary biasing force of the secondary biasing element 264b. In the case that the primary biasing force is greater than the secondary biasing force, the resulting pressure in the connecting passage 260, from the outlet 256, will overcome the secondary biasing force. The secondary biasing element 264b will be thereby caused to compress moving the secondary valve member 266b towards the secondary valve seat 268b and closing the secondary valve system 262b. The secondary valve system 262b and the secondary flow path 252b will remain closed until gas flow out of the regulator 200x through the outlet 256 results in a decrease in pressure in the secondary chamber 258b.

The presence of two flow paths, including the primary flow path 252a and the secondary flow path 252b, may be particularly advantageous if flow to the primary flow path 252a becomes blocked. Blockage may be caused, for example, by ice build-up caused by use in low temperature situations or by use with high pressure gases, the pressure drop between the inlet and the outlet having the effect of cooling the system to below the freezing temperature of liquids in the surrounding environment, such as water.

The system may be configured, such as by making the primary biasing force greater than the secondary biasing force, so that no operator intervention is required to open the secondary valve system 262b, in the case of a blockage in the primary valve system 262a. Such partial or full blockage of the primary flow path 252a will result in an opening of the secondary flow path 252b from its normally closed position previously described.

Particularly, a restriction of the primary flow path 252a will cause a reduction in flow from the primary chamber 258a and thus also cause less flow through the outlet 256, thereby causing a reduction in pressure acting upon the secondary biasing element 264b within the secondary chamber 258b via the connection passage 260. As a result, the secondary biasing force of the secondary biasing element 264b will overcome the pressure in the secondary chamber 258b causing the secondary biasing element 264b to relax. The secondary valve member 266b will be caused to move away from the secondary valve seat 268b opening the secondary flow path 252b. The regulator therefore provides backup flow passages that will enable a continuous supply of gas if the pressure of the primary flow path 252a drops due to a partial or complete blockage of the primary flow path 252a.

It will be understood by those of ordinary skill in the art that a method for using the regulator 200x may include adjusting at least one of the primary biasing element 264a or the secondary biasing element 264b such that the primary biasing element 264a has a biasing force greater than a biasing force of the secondary biasing element 264b.

Turning next to FIG. 3, a cross-sectional view of a regulator system 300x for controlling the pressure of resulting from a flow of gas from a source is illustrated. The regulator system as shown includes two regulators 200c-d as depicted in FIG. 2 at 200x, including any of the aspects previously recited. The two regulators 200c-d are connected in series, whereby the outlet 256c of the first regulator 200c is in fluidic communication with the inlet 254d of the second regulator 200d via a connection member 302. Additionally, it will be understood by one of ordinary skill in the art that more than two regulators may be connected in the same manner.

The regulator system 300x provides for backup regulation that enables a continuous regulated supply of gas if any regulator fails in the open position, whereby each biasing element 264a-b (see FIG. 2) causes each valve system 262a-b (see FIG. 2) to remain open. The result is that combined with the redundancy of multiple flow paths, the regulator system 300x can function when there is either a blocked flow path or a complete failure of at least one regulator 200x of the regulator system 300x.

In use, at least two regulators 200x as depicted in FIG. 2, and including any of the aspect previously recited, may be connected in series, such as via a connection member 302, whereby the outlet 256c of the first regulator 200c coming into contact with a gas from a source is in fluidic communication with the inlet 254d of the second regulator 200d subsequently coming into contact with the gas from a source. Additionally, the primary biasing element 264a and the secondary biasing element 264b of each regulator 200x may be adjusted, whereby for each regulator 200x, the respective primary biasing element 264a is adjusted to a primary biasing force that is greater than the secondary biasing force of the respective secondary biasing element 264b.

Turning next to FIGS. 4 through 8, a valve, such as valve 400x, for controlling a flow of a gas from a source is illustrated. The valve 400x has a body 401, which has an inlet passage 402 and an outlet passage 404. The inlet passage 402 is in fluidic communication with a valve chamber 408, such as via a passageway 406.

A valve piston 426 within the valve chamber 408 may be adapted to receive both a valve keeper 416 and a valve seat 418 into a bore 414 of the valve piston 426. The valve seat 418 communicates with a sidewall 420 of the body 401, enabling shut off and control of flow from the inlet passage 402 to the outlet passage 404. For example, the valve seat 418 may engage and disengage the sidewall 420. As shown, the valve seat 418 may be annular in shape, although it may be of any other suitable shape, and may be carried by the valve keeper 416 centrally deposed to the valve seat 418.

The valve keeper 416 may have an orifice 432 that extends through the valve keeper 416 from a contact surface 422 of the valve keeper 416, in direct contact with the flow of gas from the inlet passage 402, to the bore 414. The orifice 432 may permit gas or air to escape the bore 414 upon insertion of the valve keeper 416 into the bore 414 during manufacturing. The orifice 432 therefore reduces a risk that air trapped in the bore 414 will expand when heated, causing the valve keeper 416 to move away from the valve piston 426.

The 400x valve may be configured such that the valve keeper 416, and not the valve seat 418, is positioned in the path of the flow into the valve chamber 408 and is the initial impact point for the flow. Direct impingement of the flow velocity and high velocity particles on the valve seat 418 may thus be minimized.

When such a valve 400x is used in a critical flow system, such as a lifesaving system for delivering oxygen, the risk of gas-related fire, such as oxygen-related fire, may be reduced.

In addition, the valve keeper 416 may have a diameter at least as great as a diameter of an opening 410 of the passageway 406 into the valve chamber 408, which may further reduce the risk of gas-related fire.

In this arrangement, the valve seat 418 may be made from a non-metal such that it provides for a more efficient seal with the body 401, and the valve keeper 416 may be made from a metal such that it is more durable, though they may also be made from any other suitable material.

For example, the valve keeper 416 may be made from a nickel alloy such as Monel, and the valve seat 418 may be made from a polyimide-based polymer such as Vespel.

Additionally, both the valve keeper 416 and the valve seat 418 may be wetted by the flow through the valve and may be made from materials known to reduce the risk of fire associated with gases used with the valve 400x, such as oxygen in the case of a lifesaving system.

According to another aspect of the invention, a bonnet assembly 424 is partially retained in the valve chamber 408. The bonnet assembly 424 provides for engagement with the valve piston 426 and is adapted to move the valve piston 426 within the valve chamber 408. This movement causes the valve seat 418 to engage or disengage the sidewall 420 of the body 401, opening or closing the valve 400x, and controlling a flow of gas from the inlet passage 402 to the outlet passage 404.

Additionally, the bonnet assembly 224 may provide for isolation of at least part of an isolated component from flow through the body 401 via at least one sealing element 428.

The at least one sealing element 428 may be made of a fluoroelastomer, a polytetrafluoroethylene, a silicone, or a fluoropolymer, such as Teflon or Viton, or of any other suitable material, and may isolate at least part of a an isolated component from a possibly corrosive external environment.

The at least one isolated component may include a stem 452 extending through the bonnet assembly 424 and engaged with both the body 401 and the valve piston 426, or it may include the valve piston 426 engaged with the stem 452.

Particularly, the isolated component may include wear parts, e.g., threads, springs, and other aspects of the bonnet assembly 424 that may generate particles and heat due to friction with gas flow. In this manner, the wear parts such as threads 430 of the stem 452, for engaging with threads 431 of the valve piston 426, may be isolated.

Particles generated in other cylinder valves due to wear parts may result in fire in downstream system features due to high velocity impact.

In the valve 400x, for use in a critical flow system, such as a lifesaving system, isolating wear parts may instead reduce the risk of fire. Further, by isolating parts of or whole wear parts, internal features or parts of the bonnet assembly 424 may be made of cheaper materials, while external parts of the bonnet assembly may be made of materials more resistant to corrosive atmospheres or high velocity flow of gases through the valve 400x.

The valve piston 426, one of the isolated components, may include multiple connected elements. As shown, the valve piston 426 includes a lower valve piston body 412, e.g. a poppet, for receiving the valve keeper 416 and the valve seat 418 and having the bore 414. The valve piston 426 may also include an upper driver body 454 connected to the stem 452 via the threads 430 and 431 and engaged with the lower valve piston body 412. Therefore, as shown, part of the lower valve piston body 412 and the entirety of the upper driver body 454 are isolated from the external environment and flow through the body 401.

The bonnet assembly 424 includes several bonnet components. An upper bonnet cap 450 is engaged with the body 401. The stem 452, also a component of the bonnet assembly 424, extends through the upper bonnet cap 450 and engages with the valve piston 426.

In addition, the bonnet assembly 424 may include a lower bonnet portion 456 configured to receive the valve piston 426 and engaged with the upper bonnet cap 450 and the body 401.

The lower bonnet portion 456 may be connected, such as by threads, to the lower valve piston body 412 of the valve piston 426.

The bonnet assembly 424 may also include sealing elements 468, such as gaskets, bearings, washers, or other suitable elements, to separate the stem 452 from and cushion the stem 452 against other bonnet components, such as the upper bonnet cap 450 and the lower bonnet portion 456.

Additional sealing elements 468 may be disposed between the upper bonnet cap 450 and the stem 452, between the upper bonnet cap 450 and the body 401, and between the lower bonnet portion 456 and the body 401. Sealing elements 468 may also be disposed between the lower bonnet portion 456 and the valve piston 426, or more specifically between the lower bonnet portion 456 and both the lower valve piston body 412 and the upper driver body 454 of the valve piston 426.

A safety plug 462 may be received in a secondary passageway 464, providing a possible path of relief for gas flow prior to entrance into the valve chamber 408, thereby providing a path for release of gas from the valve 400x in the case of a possible increase in the pressure of gas entering the inlet passage 402.

The valve 400x may also include an external leak test port 466 in the upper bonnet cap 450 and an internal leak test port 470 in the lower bonnet portion 456 to provide paths for trapped gas, such as air. Such paths may allow the trapped gas to escape in the case of gas expansion due to application involving or causing high temperatures of the valve 400x.

A connecting element 458, such as a screw, disposed at least partially outside the bonnet assembly 424 connects an operator member 460, such as a handle, also outside the bonnet assembly 424, to the stem 452. As shown, rotation of the operator member 460 causes rotation of the stem 452, thereby causing the valve piston 426 to move within the bonnet assembly 424, which in turn causes the valve seat 418 to engage or disengage the sidewall 420 of the valve chamber 408. More specifically, rotation of the stem 452 causes the upper driver body 454 to move axially, thereby causing the lower valve piston body 412 to move axially. Accordingly, one of ordinary skill will realize that the bonnet assembly may include an anti-rotation feature, not specifically shown.

Although the invention has been shown and described with respect to a certain preferred embodiment or embodiments, it is obvious that equivalent alterations and modifications will occur to others skilled in the art upon the reading and understanding of this specification and the drawings. In particular, in regard to the various functions performed by the above described elements (components, assemblies, devices, compositions, etc.), the terms used to describe such elements are intended to correspond, unless otherwise indicated, to any element which performs the specified function of the described element (i.e., that is functionally equivalent). In addition, while a particular feature of the invention may have been described above with respect to only one or more of several illustrated embodiments, such feature may be combined with one or more other features of the other embodiments, as may be desired and advantageous for any given or particular application. The use of “comprising” or “comprise” herein is intended to include the recited components without exclusion of other components.

1. A gas supply assembly for controlling a flow and regulating a pressure of gas from a source comprising:
a valve (400x) for controlling the flow of gas from at least one gas vessel (104x), wherein the valve (400x) comprises:
a body (401) having an inlet passage (402) and an outlet passage (404), wherein the inlet passage (402) is in fluidic communication with a valve chamber (408);
a valve piston (426) associated with the valve chamber (408) and receiving a valve keeper (416) and a valve seat (418), wherein the valve keeper (416) is positioned in the path of the flow into the valve chamber (408) and is impacted upon by the flow; and
a bonnet assembly (424) for engaging with the valve piston (426) and isolating at least part of at least one component from flow through the body (401) and from the environment, wherein the bonnet assembly (424) is adapted to move the valve piston (426) within the valve chamber (408 causing the valve seat (418) to engage or disengage the sidewall (420); and
a regulator (200x) for regulating the pressure of a gas from the at least one gas vessel (104x), connected downstream of the valve (400x), the regulator (200x) comprising:
a housing (250);
a primary flow path (252a) and a secondary (252b) flow path within the housing (250), the primary flow path (252a) providing for flow from the inlet (254) to the outlet (256) through a primary chamber (258a), and the secondary flow path (252b) providing for flow from the inlet (254) to the outlet (256) through a secondary chamber (258b); and
a connecting passage (260) providing fluidic communication between the primary chamber (258a), the secondary chamber (258b), and the outlet (256);
a primary valve system (262a) housed within the primary chamber (258a) for opening and closing the primary flow path (252a), and a secondary valve system (262b) housed within the secondary chamber (258b) for opening and closing the secondary flow path (252b);
a primary biasing element (264a) housed within the primary chamber (258a) and engaging the primary valve system (262a), and a secondary biasing element (264b) housed within the secondary chamber (258b) and engaging the secondary valve system (262b);
wherein each of the biasing elements is adapted to bias the respective valve system in an open position allowing flow from the inlet (254) to the outlet (256), and is also adapted to close the respective valve system when exposed to a pressure at the outlet (256) sufficient to create a force equal to or greater than a biasing force of the respective biasing element.

2. A regulator (200x) for regulating the pressure of a gas from at least one gas vessel (104x), connected downstream of a valve (400x), the regulator (200x) comprising:
a housing (250);
a primary flow path (252a) and a secondary (252b) flow path within the housing (250), the primary flow path (252a) providing for flow from the inlet (254) to the outlet (256) through a primary chamber (258a), and the secondary flow path (252b) providing for flow from the inlet (254) to the outlet (256) through a secondary chamber (258b); and
a connecting passage (260) providing fluidic communication between the primary chamber (258a), the secondary chamber (258b), and the outlet (256);
a primary valve system (262a) housed within the primary chamber (258a) for opening and closing the primary flow path (252a), and a secondary valve system (262b) housed within the secondary chamber (258b) for opening and closing the secondary flow path (252b);
a primary biasing element (264a) housed within the primary chamber (258a) and engaging the primary valve system (262a), and a secondary biasing element (264b) housed within the secondary chamber (258b) and engaging the secondary valve system (262b);
wherein each of the biasing elements is adapted to bias the respective valve system in an open position allowing flow from the inlet (254) to the outlet (256), and is also adapted to close the respective valve system when exposed to a pressure at the outlet (256) sufficient to create a force equal to or greater than a biasing force of the respective biasing element.

3. The gas supply assembly of claim 1 or the regulator of claim 2, wherein the primary biasing element (264a) and the secondary biasing element (264b) are adjusted to different biasing forces.

4. The gas supply assembly or regulator of any one of the preceding claims, wherein the primary biasing element (264a) is adjusted to a primary biasing force greater than a secondary biasing force of the secondary biasing element (264b).

5. The gas supply assembly or regulator of any one of the preceding claims, wherein the primary biasing element (264a) and the secondary biasing element (264b are adjusted such that when gas flows in the inlet (254) and out the outlet (256), the primary biasing force of the primary biasing element (264a) overcomes the pressure resulting from flow from the inlet (254) and pressure at the outlet (256) such that the primary valve system (262a) is open, and the pressure resulting from flow from the inlet (254) and pressure at the outlet (256) overcome the secondary biasing force of the secondary biasing element (264b) closing the secondary valve system (262b).

6. The gas supply assembly or regulator of any one of any one of the preceding claims, wherein a restriction of the primary flow path (252a) causes a decrease of the pressure resulting from flow from the outlet (256), thereby causing the secondary biasing force of the secondary biasing element (264b) to overcome the pressure resulting from flow from the outlet (256) opening the secondary valve system (262b).

7. The gas supply assembly or regulator of any one of the preceding claims, wherein no operator intervention is required to open the secondary valve system (262b).

8. The gas supply assembly or regulator of any one of the preceding claims, wherein the primary valve system (262a) comprises a primary valve member (266a) centrally deposed to a primary valve seat (268a) and engaged with the primary biasing element (264a) such that an increase of the pressure resulting from flow to the primary chamber (258a) causes the primary valve member (266a) to move axially towards the primary valve seat (268a), and a decrease of the pressure resulting from flow from the primary chamber (258a) causes the primary valve member (266a) to move axially away from the primary valve seat (268a).

9. The gas supply assembly or regulator of any one of the preceding claims, wherein the secondary valve system (262b) comprises a secondary valve member (266b) centrally deposed to a secondary valve seat (268b) and engaged with the secondary biasing element (264b) such that an increase of the pressure resulting from flow to the secondary chamber (258b) causes the secondary valve member (266b) to move axially towards the secondary valve seat (268b), and a decrease of the pressure resulting from flow from the secondary chamber (258b) causes the secondary valve member (266b) to move axially away from the secondary valve seat (268b).

10. The gas supply assembly or regulator of any one of the preceding claims, wherein the connecting passage (260) forms part of at least one of the primary flow path (252a) or the secondary flow path (252b).

11. The gas supply assembly or regulator of any one of the preceding claims, wherein at least one of the primary valve seat (268a) or the secondary valve seat (268b) comprises at least one of a nickel alloy or a polyimide-based plastic.

12. The gas supply assembly or regulator of any one of the preceding claims, wherein the primary biasing element (264a) is sealed off from flow through the primary flow path (252a) and from the environment by at least one primary sealing element (270a).

13. The gas supply assembly or regulator of claim 12, wherein the at least one primary sealing element (270a) comprises a fluoroelastomer, a polytetrafluoroethylene, a silicone, or a fluoropolymer.

14. The gas supply assembly or regulator of any one of the preceding claims, wherein the secondary biasing element (264b) is sealed off from flow through the secondary flow path (252b) and from the environment by at least one secondary sealing element (70b).

15. The gas supply assembly or regulator of any one of the preceding claims, wherein the at least one secondary sealing element (270b) comprises a fluoroelastomer, a polytetrafluoroethylene, a silicone, or a fluoropolymer.

16. A valve (400x) for controlling the flow of gas from at least one gas vessel (104x), wherein the valve (400x) comprises:
a body (401) having an inlet passage (402) and an outlet passage (404), wherein the inlet passage (402) is in fluidic communication with a valve chamber (408);
a valve piston (426) associated with the valve chamber (408) and receiving a valve keeper (416) and a valve seat (418), wherein the valve keeper (416) is positioned in the path of the flow into the valve chamber (408) and is impacted upon by the flow; and
a bonnet assembly (424) for engaging with the valve piston (426) and isolating at least part of at least one component from flow through the body (401) and from the environment, wherein the bonnet assembly (424) is adapted to move the valve piston (426) within the valve chamber (408 causing the valve seat (418) to engage or disengage the sidewall (420).

17. The gas supply assembly or valve of any one of the preceding claims, wherein a passageway (406) provides for fluidic communication between the inlet passage (402) and the valve chamber (408) and has an opening (410), wherein the valve keeper (416) has a diameter at least as great as a diameter of the opening (410).

18. The gas supply assembly or valve of any one of the preceding claims, wherein the valve keeper (416) is centrally deposed to the valve seat (418) and retains the valve seat (418) in the valve piston (426).

19. The gas supply assembly or valve of any one of the preceding claims, wherein the valve seat (418) has an annular shape.

20. The gas supply assembly or valve of any one of the preceding claims, wherein the valve piston (426) has a bore (414) for receiving the valve keeper (416), the valve keeper (416) has a contact surface (422) positioned in the path of the flow into the valve chamber (408), and the valve keeper (416) has an orifice (432) extending through the valve keeper (416) from the contact surface (422) to the bore (414).

21. The gas supply assembly or valve of any one of the preceding claims, wherein at least one of the valve keeper (416) or the valve seat (418) comprises at least one of a nickel alloy or a polyimide-based polymer.

22. The gas supply assembly or valve of any one of the preceding claims, wherein the at least one component is isolated from flow through the body (401) and from the environment by at least one sealing element (428).

23. The gas supply assembly or valve of any one of the preceding claims, wherein the at least one sealing element (428) comprises at least one of a fluoroelastomer, a polytetrafluoroethylene, a silicone, or a fluoropolymer.

24. The gas supply assembly or valve of any one of the preceding claims, wherein the at least one component comprises at least one of:
a stem (452) extending through the bonnet assembly (424) and engaged with the body (401) and the valve piston (426); or
the valve piston (426) engaged with the stem (452).

25. The gas supply assembly or valve of any one of the preceding claims, wherein the at least one component includes threads (430).

26. The gas supply assembly or valve of any one of the preceding claims, wherein the bonnet assembly (424) comprises:
an upper bonnet cap (450) engaged with the body (401);
a stem (452) extending through the upper bonnet cap (450) and engaged with the valve piston (426);
a lower bonnet portion (456) configured to receive the valve piston (426) and engaged with the upper bonnet cap (450) and the body (401); and
a connecting element (458) outside the bonnet assembly (424) connecting an operator member (460) outside the bonnet assembly (424) to the stem (452);
wherein rotation of the operator member (460) causes rotation of the stem (452), thereby causing the valve piston (426) to move within the bonnet assembly (424), thereby causing the valve seat (418) to engage or disengage the sidewall (420) of the valve chamber (408).

27. The gas supply assembly or valve of any one of the preceding claims, wherein the valve piston (426) is comprised of:
a lower valve piston body (412) for receiving the valve keeper (416) and the valve seat (418) and having the bore (414); and
an upper driver body (454) connected to a stem (452) and engaged with the lower valve piston body (412), wherein the stem (452) extends through the bonnet assembly (424) and engages with the body (401).

28. A regulator system (300x) for regulating the pressure of a gas from the at least one gas vessel (104x), connected downstream of the valve (400x), wherein the regulator system comprises:
the regulator (200x) according to any of the preceding claims and being a first regulator (200c); and
a second regulator (200d) according to any of the preceding claims;
wherein the first and second regulators (200c and 200d) are connected in series; and
wherein an outlet (256c) of the first regulator (200c) is in fluidic communication with an inlet (254d) of the second regulator (200d).

29. A method of using a regulator (200x) according to any of any of the preceding claims to control the pressure resulting from a gas flowing from a source, comprising the steps of:
adjusting at least one of the primary biasing element (264a) or the secondary biasing element (264b) such that the primary biasing element (264a) has a primary biasing force greater than a secondary biasing force of the secondary biasing element (264b).

30. A regulator (200x) for regulating the pressure of a gas from a source, comprising:
a housing (250);
a primary flow path (252a) and a secondary (252b) flow path within the housing (250), the primary flow path (252a providing for flow from an inlet (254) to an outlet (256) through a primary chamber (258a), and the secondary flow path (252b) providing for flow from the inlet (254) to the outlet (256) through a secondary chamber (258b); and
a connecting passage (260) providing fluidic communication between the primary chamber (258a), the secondary chamber (258b), and the outlet (256);
a primary valve system (262a) housed within the primary chamber (258a) for opening and closing the primary flow path (252a), and a secondary valve system (262b) housed within the secondary chamber (258b) for opening and closing the secondary flow path (252b);
a primary biasing element (264a) housed within the primary chamber (258a) and engaging the primary valve system (262a), and a secondary biasing element (264b housed within the secondary chamber (258b) and engaging the secondary valve system (262b);
wherein each of the biasing elements is adapted to bias the respective valve system in an open position allowing flow from the inlet (254) to the outlet (256), and is also adapted to close the respective valve system when exposed to a pressure at the outlet (256) sufficient to create a force equal to or greater than a biasing force of the respective biasing element.

31. A valve for controlling a flow of a gas from a source comprising:
a body (401) having an inlet passage (402) and an outlet passage (404), wherein the inlet passage (402) is in fluidic communication with a valve chamber (408);
a valve piston (426) associated with the valve chamber (408) and receiving a valve keeper (416) and a valve seat (418), wherein the valve seat (418) cooperates with a sidewall (420) of the valve chamber (408) to seal off the flow to the valve chamber (408), and wherein the valve keeper (416) is positioned in the path of the flow into the valve chamber (408) and is impacted upon by the flow; and
a bonnet assembly (424) for engaging with the valve piston (426) and isolating at least part of at least one component from flow through the body (401) and from the environment, wherein the bonnet assembly (424) is adapted to move the valve piston (426) within the valve chamber (408) causing the valve seat (418) to engage or disengage the sidewall (420).
